(19) United States
(12) Patent Application Publication
(10) Pub. No.: US 2025/0168489 A1
(43) Pub. Date: May 22, 2025

(54) METHOD AND SYSTEM FOR ENHANCED UNDER-DISPLAY CAMERA IMAGING

(71) Applicant: SAMSUNG ELECTRONICS CO., LTD., Suwon-si (KR)

(72) Inventors: Aakash ARORA, Bengaluru (IN); Ankur HARKAWAT, Bengaluru (IN)

(73) Assignee: SAMSUNG ELECTRONICS CO., LTD., Suwon-si (KR)

(21) Appl. No.: 19/025,286

(22) Filed: Jan. 16, 2025

Related U.S. Application Data
(63) Continuation of application No. PCT/KR2023/011428, filed on Aug. 3, 2023.

(30) Foreign Application Priority Data
Sep. 9, 2022 (IN) 202241051647
Apr. 5, 2023 (IN) 202241051647

(51) Int. Cl. H04N 23/63; G09G 3/00; G09G 5/12

(52) U.S. Cl. CPC H04N 23/63; G09G 3/002; G09G 5/12; G09G 2300/023

(57) ABSTRACT

A method performed by an electronic device, includes: receiving an input to initiate an image capturing operation using an under-display camera positioned under an aperture region of a primary display of the electronic device; detecting a modulation rate of the primary display, wherein the modulation rate includes an ON period and an OFF period; determining a current operating frame rate of the under-display camera; synchronizing, when the image capturing operation is in progress, the current operating frame rate associated with the under-display camera with the detected modulation rate. The synchronizing includes: providing display functionality around the aperture region during the ON period of a primary display region overlapping with the aperture region; and performing image capture, by the under-display camera, during the OFF period of the primary display region overlapping with the aperture region.

### CROSS-REFERENCE TO RELATED APPLICATIONS

This application is a by-pass continuation application of International Application No. PCT/KR2023/011428, filed on Aug. 3, 2023, which is based on and claims priority to Indian patents application Ser. Nos. 202241051647, filed on Sep. 9, 2022, and 202241051647, filed on Apr. 5, 2023, in the Indian Intellectual Property Office, the disclosures of which are incorporated by reference herein their entireties.

### BACKGROUND

### 1. Field

The disclosure relates to a method and a system for under-display camera imaging. In particular, the disclosure enables simultaneous use of the under-display camera and display by synchronizing an operating frame rate of the under-display camera with a modulation rate (e.g., a pulse width modulation (PWM) rate) of a primary display, such that a user capture images while the camera remains hidden.

### 2. Description of Related Art

With the advancement of mobile technology, many mobile devices, such as smartphones and tablets, feature a front camera. Thus, due to the usage of the front camera, there is an increasing inclination for such mobile devices to contract the display's bezel. A bezel surrounds a screen of the smartphone. Thus, contracting the display's bezel may result in the enhancement of user experience as the entire screen may be utilized by the display. However, components like the front camera deployed in the bezel become a significant hurdle in achieving this objective.

Further, various solutions were provided where the front camera is deployed under the display with an opening through a punch-hole or a notch 101 for performing a capturing operation as shown in FIG. 1. However, the solutions with the punch-hole or the notch are unappealing as they provide a poor user experience. Further, such solutions merely progress towards the full edge-to-edge display.

Further, according to the related art as shown in FIG. 1 a main screen has normal pixel density while an area above the camera has lesser pixel density allowing for more light to pass through the display to the cameras. However, such an arrangement gives rise to various shortcomings as listed below.

The camera quality gets reduced due to the loss of light passing through the display. As the display over the camera has lesser pixels, the quality of this display area is poor when compared with the rest of the area of the same display. Further, this part of the display is distinguishably visible to the end user, thereby leading to a poor user experience.

According to the related art, a sub-display type is included in the electronic device. It consists of a driver-controlled secondary display, which can slide between the camera and the aperture. This secondary display covers the aperture, making the screen appear notch-less. Now, when the secondary display slides down, the light from the aperture can enter the camera, which then captures and processes it. However, the aforesaid solution provides various shortcomings listed below:

As the related art provides a mechanical solution, hence such solutions are less reliable and prone to many errors. The related art provides slower switching times between two operating modes. Further, it is unsuitable for simultaneous usage or operations like front-face unlock.

Thus, there is a need to provide a method where an under-display camera is able to hide, while it is functional, and the user can view the entire content on the screen without any obstructions of the punch-hole or the notch without being mechanical in nature.

### SUMMARY

Provided are a method and a system for an under-display camera. Provided is an enhanced imaging technique using the under-display camera without displaying an aperture area while capturing images using the under-display camera.

According to an aspect of the disclosure, a method performed by an electronic device, includes: receiving an input to initiate an image capturing operation using an under-display camera positioned under an aperture region of a primary display of the electronic device; detecting a modulation rate of the primary display, wherein the modulation rate includes an ON period and an OFF period; determining a current operating frame rate of the under-display camera; synchronizing, when the image capturing operation is in progress, the current operating frame rate associated with the under-display camera with the detected modulation rate, wherein the synchronizing includes: providing display functionality around the aperture region during the ON period of a primary display region overlapping with the aperture region; and performing image capture, by the under-display camera, during the OFF period of the primary display region overlapping with the aperture region.

According to an aspect of the disclosure, an electronic device includes: a primary display and a secondary display; a projection system that is under the primary display and is in front of the secondary display, wherein the projection system includes multiple refractive and reflective elements and the projection system is configured to congregate and project the light from the secondary display onto an aperture region in the primary display; an under-display camera below the aperture region; and at least one processor operatively connected with the projection system, the primary display, the secondary display, and the under-display camera, wherein the at least one processor is configured to: receive an input to initiate an image capturing operation using the under-display camera; detect a modulation rate of the primary display, wherein the modulation rate includes an ON period and an OFF period; determine a current operating frame rate of the under-display camera; synchronize, when the image capturing operation is in progress, the current operating frame rate associated with the under-display camera with the detected modulation rate, and wherein the synchronizing includes: providing display functionality around the aperture region during the ON period of a primary display region overlapping with the aperture region; and performing image capture, by the under-display camera, during the OFF period of the primary display region overlapping with the aperture region.

To further clarify the advantages and features of the disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

### BRIEF DESCRIPTION OF THE DRAWINGS

These and other features, aspects, and advantages of the disclosure will become better understood when the following detailed description is read with reference to the accompanying drawings in which like characters represent like parts throughout the drawings, wherein:

FIG. 1 illustrates a display system of the related art;

FIG. 2 illustrates a smartphone that displays to adjust their brightness in accordance with the related art;

FIG. 3A illustrates an example of a display arrangement for enhanced under-display camera imaging, according to an embodiment of the disclosure;

FIG. 3B illustrates a block diagram of an electronic device according to an embodiment of the disclosure;

FIGS. 4A and 4B illustrate an operational flow for the under-display camera imaging for an electronic device, according to an embodiment of the disclosure;

FIG. 5A illustrates an arrangement for the under-display camera imaging for an electronic device with an invisible aperture, according to an embodiment of the disclosure;

FIG. 5B illustrates another operational flow chart for the under-display camera imaging for the electronic device, according to a further embodiment of the disclosure;

FIGS. 6 illustrates various projection system arrangements, according to an embodiment of the disclosure;

FIG. 7 illustrates an exemplary scenario for real-time face authentication in a sub-display system, according to an example embodiment of the disclosure;

FIG. 8 illustrates an exemplary scenario for handling slow motion scenarios, according to an example embodiment of the disclosure; and

FIG. 9 illustrates a comparison of an output with respect to the related art, according to an example embodiment of the disclosure.

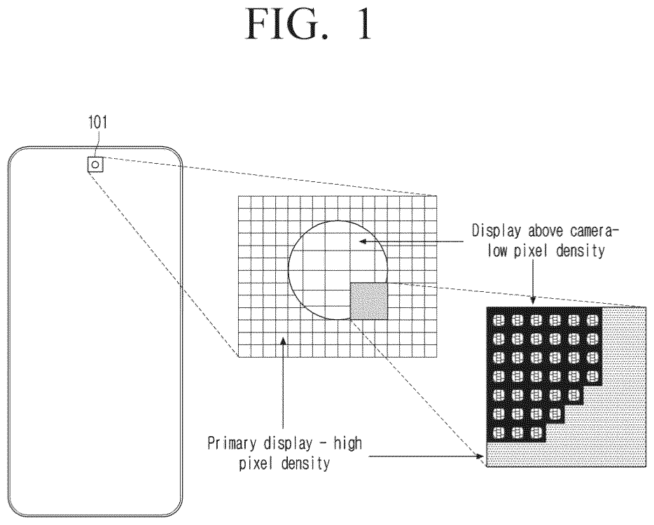

The drawings may show only those specific details that are pertinent to understanding the embodiments of the disclosure so as not to obscure the drawings with details that will be readily apparent to those of ordinary skill in the art having the benefit of the description herein.

### DETAILED DESCRIPTION

Although illustrative implementations of the embodiments of the disclosure are illustrated below, the disclosure may be implemented using any number of techniques, whether currently known or in existence. The disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching, and illuminating some embodiments and their specific features and elements and does not limit, restrict, or reduce the spirit and scope of the claims or their equivalents.

More specifically, any terms used herein such as but not limited to “includes,” “comprises,” “has,” “consists,” and grammatical variants thereof do not specify an exact limitation or restriction and certainly do not exclude the possible addition of one or more features or elements, unless otherwise stated, and furthermore must not be taken to exclude the possible removal of one or more of the listed features and elements, unless otherwise stated with the limiting language “must comprise” or “needs to include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language such as “there needs to be one or more . . . ” or “one or more element is required.”

The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

Moreover, multiple functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Unless otherwise defined, all terms, and especially any technical and/or scientific terms, used herein may be taken to have the same meaning as commonly understood by one having ordinary skill in the art. Embodiments of the disclosure will be described below in detail with reference to the accompanying drawings.

The disclosure proposes a method and system for an under-display camera. The disclosure discloses an enhanced imaging technique using the under-display camera without displaying an aperture area while capturing images using the under-display camera. The technique is based on synchronizing an operating frame rate of the under-display camera with a modulation rate (e.g. a PWM rate) of a primary display.

Throughout the disclosure, the PWM and the PWM rate are descried as non-limiting examples. In some embodiments, the PWM and the PWM rate are replaced with other modulation schemes and their rates, such as Pulse-Amplitude Modulation (PAM), Pulse-Frequency Modulation (PFM), Pulse-Position Modulation (PPM), Delta-Sigma Modulation (DSM), or Space Vector Modulation (SVM).

The synchronization of the operating frame rate is configured such that a user capture images while the camera remains hidden. According to the disclosure, the PWM rate of the primary display matches with the operating frame rate of the under-display camera. Thus, the synchronization enables display functionality around the aperture region during a PWM ON period of the primary display region overlapping with the aperture region. The synchronizing further enables image capture by the under-display camera during a PWM OFF period while the primary display region overlaps with the aperture region. The disclosure further provides a unique hardware arrangement to achieve enhanced imaging using the under-display camera without displaying the aperture area.

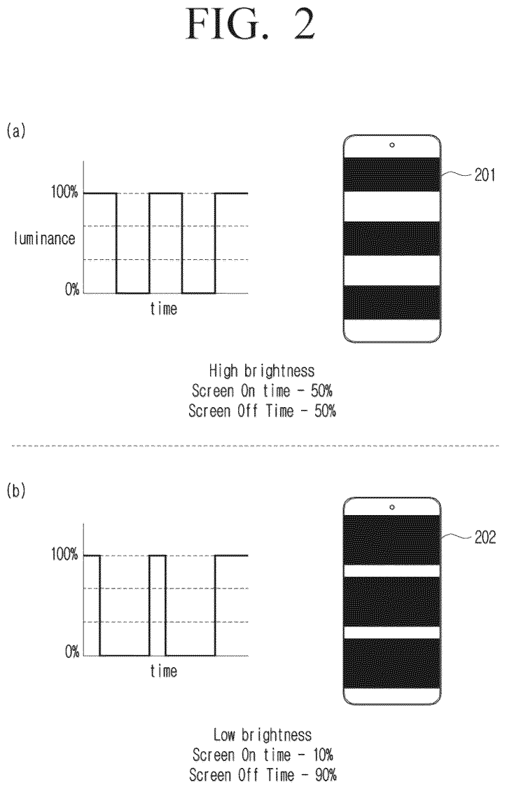

According to the related art, the displays in an electronic device, for example, smartphone displays, adjust their brightness by using a technique called PWM. FIG. 2 illustrates the related art in which the smartphone adjusts the brightness of the display. The smartphone displays are composed of light-emitting diodes (LEDs) or organic light-emitting diodes (OLEDs). According to a diode's physical properties, it is known that the diodes cannot be dimmed significantly by changing the intensity of a current, without impacting the color of light. Hence, a common method to regulate the brightness of the electronic device is using the PWM technique. According to the PWM technique, the diodes are turned ON and OFF at varying rates. The utilization of the PWM technique in smartphone displays is based on the concept that a human eye is typically not able to detect the switching between OFF and ON of the diodes as it occurs at very high rates. The human brains perceive the screen as simply dimmer overall. This phenomenon is also known as a ‘brain-averaging effect.’ Further, the level of brightness depends on how long the diodes are OFF versus how long they are ON. The longer the diodes are ON, the longer the screen is OFF and the dimmer screen brightness shall appear as shown in part (b) of FIG. 2. Further, continuous switching between ON and OFF of the diodes due to the PWM dimming results in black bands 501, also known as flicker bars that start appearing on the screen. The black bands usually move from top to bottom. Further, the black bands may be in any orientation.

According to an aspect of the disclosure, a camera image capture is synchronized with the passing of black bands, which is caused by the PWM. This enables simultaneous use of the camera and the secondary display, such that a user can capture images using the under-display camera while the camera remains hidden. Since the naked human eye is not able to detect this process, any displayed content is visible to the user on the entire screen i.e., edge-to-edge including the aperture area (e.g., a punch hole).

According to an embodiment, an electronic device includes a primary display with an aperture and an under-display camera. A function of the display is carried out by the aperture including enabling a display functionality through the aperture using a secondary display positioned under the primary display. According to an embodiment, in response to (or based on) an initiation of imaging using an under-display camera of the electronic device, a PWM rate of the primary display of the electronic device and a current operating frame rate for the image capture using the under-display camera is determined in parallel. Thereafter, the electronic device synchronizes the current frame rate of the under-display camera with the PWM rates of the primary display and the secondary display such that, during an image capture operation, the aperture simultaneously carries out the functions of the primary display and the under-display camera.

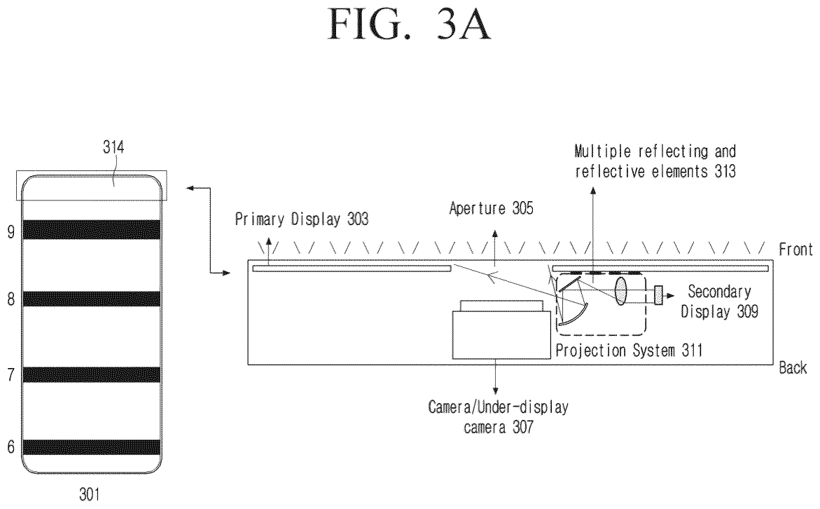

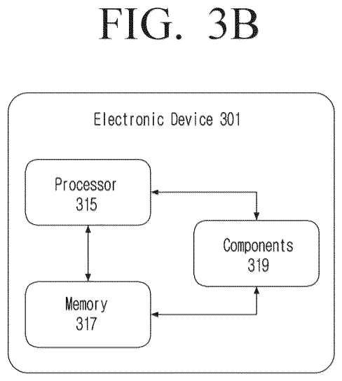

FIG. 3A illustrates an example of a display arrangement for enhanced under-display camera imaging, according to an embodiment of the disclosure. As shown in FIG. 3A, the electronic device 301 includes a primary display 303 with an aperture (a punch-hole) 305, a camera/under-display camera 307, a secondary display 309, and a projection system 311. The under-display camera 307 is present below the aperture 305 with the secondary display 309 present on its side. The primary display 303 is the screen visible directly to the user. As an example, the primary display may be an LED, an LCD, and the like. The secondary display 309 is present below the primary display 303 and is not visible to the user. The projection system 311 may include multiple refractive and reflective elements 313 that congregate light from the secondary display 309 and project it onto the aperture 305.

FIG. 3B illustrates a block diagram of an electronic device according to an embodiment of the disclosure. As an example, the electronic device 301 may correspond to various devices such as a smartphone, personal computer (PC), a tablet PC, a personal digital assistant (PDA), a mobile device, a palmtop computer, a laptop computer, a desktop computer, a communications device, dashboard, navigation device, a computing device, or any other machine capable of executing a set of instructions. The electronic device consists of a processor 315, a memory 317, and components 319.

For example, a processor 315 may be a single processing unit or a number of processing units, all of which may include multiple computing units. The processor 315 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 315 is configured to fetch and execute computer-readable instructions and data stored in a memory 317.

The memory 317 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

In an embodiment, the components 319 may include a program, a subroutine, a portion of a program, a software component or a hardware component capable of performing a stated task or function. As used herein, the components 319 may be implemented on a hardware component such as a server independently of other modules, or a module can exist with other modules on the same server, or within the same program. The components 319 may be implemented on a hardware component such as processor one or more microprocessors, microcomputers, microcontrollers, digital signal processors, central processing units, state machines, logic circuitries, and/or any devices that manipulate signals based on operational instructions. The components 319 when executed by the processor(s) may be configured to perform any of the described functionalities.

The components 319 may be implemented with an artificial intelligence (AI) model that may include a plurality of neural network layers. Examples of neural networks include, but are not limited to, convolutional neural network (CNN), deep neural network (DNN), recurrent neural network (RNN), Restricted Boltzmann Machine (RBM). The learning technique underlying the neural networks is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning. At least one of a plurality of CNN, DNN, RNN, RMB models and the like may be implemented to thereby achieve execution of the present subject matter's mechanism through an AI model. A function associated with AI may be performed through the non-volatile memory, the volatile memory, and the processor. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). One or plurality of processors control the processing of the input data in accordance with a predefined operating rule or artificial intelligence (AI) model stored in the non-volatile memory and the volatile memory. The predefined operating rule or artificial intelligence model is provided through training or learning.

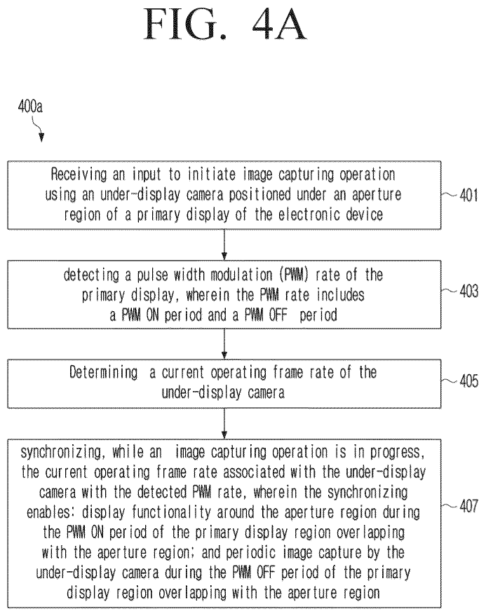

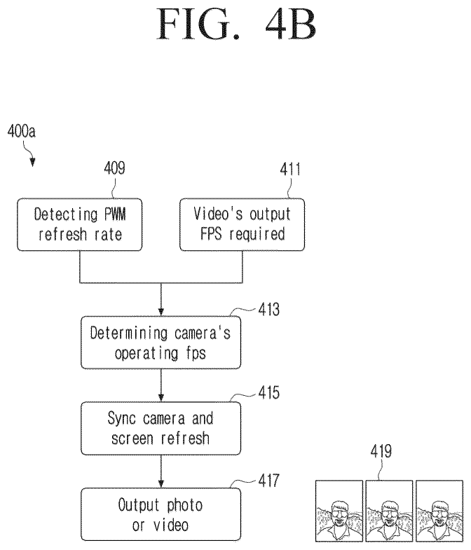

FIGS. 4A and 4B illustrate an operational flow for the under-display camera imaging for an electronic device, according to an embodiment of the disclosure. FIG. 4A shows method 400a for the under-display camera imaging. FIG. 4B shows a system flow 400b for the under-display camera imaging according to an embodiment of the disclosure. The method 400a and 400b are implemented in the electronic device 301 as shown in FIG. 3. According to an embodiment, methods 400a and 400b are performed by processor 315 of the electronic device 301. The method 400a will be explained by referring to FIGS. 3 and 4B.

At operation 401, the processor 315 of the electronic device 301 is configured to receive an input to initiate the image-capturing operation using the under-display camera 307 positioned under an aperture region of a primary display 303 of the electronic device 301. Thereafter, at operation 403, the processor 315 of the electronic device 301 is configured to detect a PWM rate of the primary display 303. The PWM rate includes a PWM ON period and a PWM OFF period. In particular, the processor 315 is configured to detect a PWM rate and video output's frame-per-second (FPS) required as shown in operation 409 and operation 411 for determining a current operating frame rate. The PWM rate may be alternatively referred to as a ‘refresh rate’ or a ‘PWM refresh rate’ throughout the disclosure. Thereafter, the processor 315 of the electronic device 301 is configured to determine the current operating frame rate of the under-display camera 307 at operation 405. In particular, the processor 315 determines the camera's 307 FPS as shown in operation 413. Operation 405 corresponds to operation 413. Thereafter, at operation 407, the processor 315 is configured to synchronize, the current operating frame rate associated with the under-display camera 307 with the detection of the primary display 303 while the image-capturing operation is in progress. Thus, according to an embodiment of the disclosure, the synchronizing enables the display functionality around the aperture region of the aperture 305 during the PWM ON period of the primary display region overlapping with the aperture region of the aperture 305. The synchronization further enables an image capture by the under-display camera 307 during the PWM OFF period of the primary display region overlapping with the aperture region of the aperture 305.

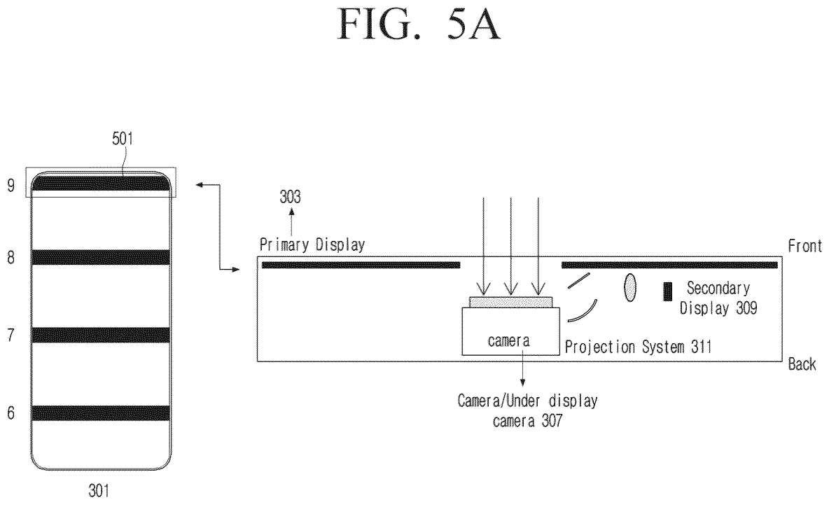

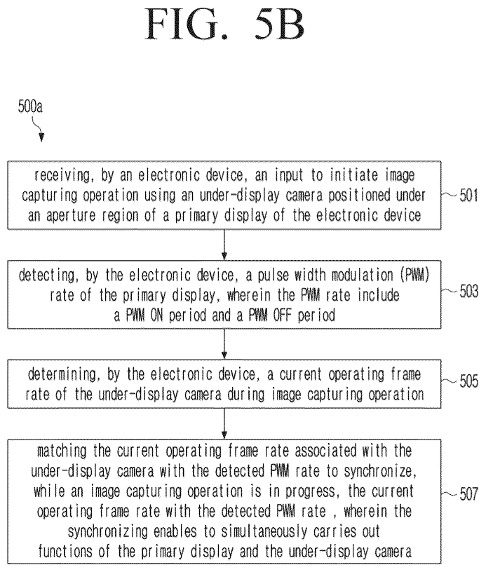

Accordingly, the current operating frame rate associated with the under-display camera matches with the detected PWM rate to synchronize the current operating frame rate with the detected PWM rate while an image-capturing operation is in progress. Thus, the synchronizing enables simultaneously carrying out functions of the primary display and the under-display camera. The enablement of the display functionality and the image capture by the under-display camera 307 will be explained in the FIG. 3A and FIG. 5A.

Referring back to FIG. 3A, when the display content from the secondary display 309 is projected onto the aperture 305 and at the same instant the display content from the primary display 303 is in synchronization with each other, to the end-user it appears as one full image without obstruction from any notch. The primary display region of the primary display 303 overlaps the aperture region during the PWM ON period of the primary display 303 and due this reason to the end-user it appears as one full image without obstruction from any notch. According to an embodiment, the display functionality in the aperture region of the primary display 303 during the PWM ON is enabled using a secondary display 309. Therefore, according to the disclosure, to the end-user it appears as one full image without obstruction from any notch.

FIG. 5A illustrates an arrangement for the under-display camera imaging for an electronic device with an invisible aperture, according to an embodiment of the disclosure. As shown in FIG. 5A the camera's image capture operation is synchronized with a passing of black bands 501. As explained above the passing of the black bands 501 is caused by PWM dimming. The under-display camera 307 and the secondary display 309 is enabled such that the user can capture images using the under-display camera 307.

Thus, according to an embodiment of the disclosure, the simultaneous use of the under-display camera 307 and the secondary display 309 is enabled such that the user can capture images using the under-display camera 307 while the under-display camera 307 remains hidden. Since the naked human eye is not able to detect this process, the display content is visible to the user on the entire screen, edge-to-edge including the aperture area. Thus, the under-display camera 307 remains invisible to the human eye when the image capture by the under-display camera during the PWM OFF period of the primary display region is in operation and the primary display 303 and the secondary display 309 are in synchronization.

Accordingly, the display functionality of the primary display 303 enabled when the primary display region overlaps the aperture region based on a result of the synchronization and thereby enabling an image capture by the under-display camera 307 at the same instance when the primary display region overlaps the aperture region. Thus, the display functionality enables during the PWM ON period and the image capture by the under-display camera 307 enables during the PWM OFF period.

According to an exemplary scenario of FIG. 5, the PWM refresh rate is at 180 Hz (black-band passes 180 times per second), and the camera's video output at 60 FPS. Thus, capturing one frame for every three passes of black bands/PWM off signal. Accordingly, operation 407 corresponds to operation 415. Thus, after the imaging operation a video or photo 419 is outputted at operation 417.

FIG. 5B illustrates another operational flow chart for the under-display camera imaging for the electronic device, according to a further embodiment of the disclosure. FIG. 5B shows method 500a for the under-display camera imaging. The method 500a are implemented in the electronic device 301 as shown in FIG. 3. According to an embodiment, methods 500a is performed by the processor 315 of the electronic device 301. The method 500a will be explained by referring to FIGS. 3, 4A, and 5A.

In an operation, at operation 501, the processor 315 of the electronic device 301 is configured to receives the input to initiate image capturing operation using the under-display camera 307 positioned under the aperture region of a primary display 303 of the electronic device 301. Thereafter, at operation 503, the processor 315 of the electronic device 301 is configured to detects, the PWM rate of the primary display 303. After detecting the PWM rate of the primary display 303, at operation 505, the processor 315 of the electronic device 301 is configured to determine the current operating frame rate of the under-display camera 307 during image capturing operation. Operations 501 to 505 correspond to operations 401 to 405 of FIG. 4A, therefore detailed explanation of the corresponding operations is omitted here.

According to the embodiment, after determining the current operating frame rate, at operation 507, the processor 315 of the electronic device 301 is configured to match the current operating frame rate associated with the under-display camera 307 with the detected PWM rate to synchronize the current operating frame rate with the detected PWM rate while the image capturing operation is in progress. Thus, the synchronizing enables to simultaneously carries out the functions of the primary display 303 and the under-display camera 307. Further, the functions of the primary display 303 and the under-display camera 307 are illustrated in FIG. 3A and FIG. 5A, thus detailed explanation of the same is omitted here.

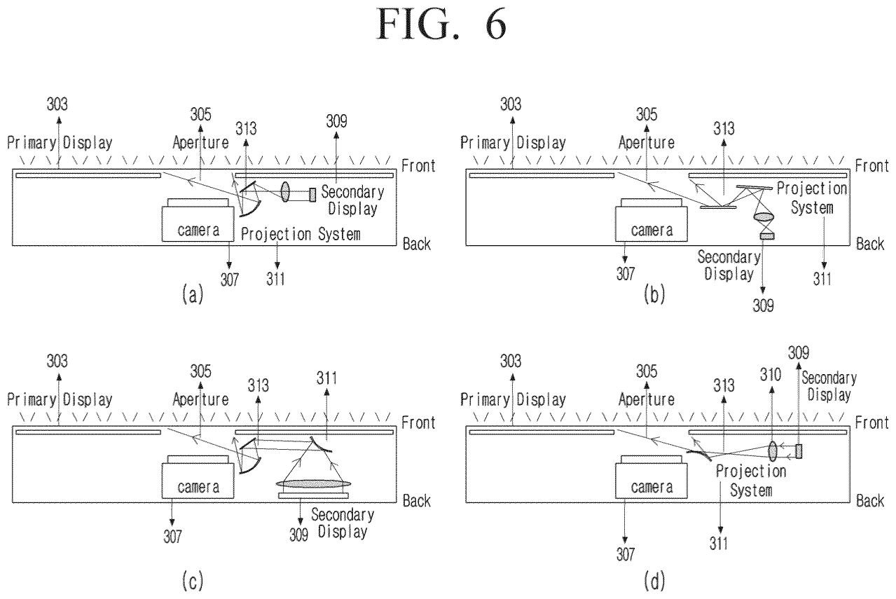

FIG. 6 illustrates various projection system arrangements, according to an embodiment of the disclosure. FIG. 6 shows a few projection arrangements as a non-limiting example. As explained above in FIG. 3A, the projection system 311 may include multiple reflective and refractive elements 313 of varying power to project and focus the image from the secondary display 309 onto the aperture area. The secondary display 309 is present below the primary display 303, in a casing of the electronic device 301. According to embodiment, the projection system 311 is present outside the aperture region such that the projection system 311 does not obstruct the light from the aperture 305 to the camera 307. The camera may be alternatively referred as the under-display camera throughout the disclosure.

In FIG. 6, (a) shows a projection system 311 with a plane mirror and concave mirror at the exit, with a plurality of lens system present between the mirror and secondary display for gathering and focusing the light. The arrangement as shown in (a) of FIG. 6 is same as shown in FIG. 3A. In FIG. 6, (b) shows a projection system 311 with multiple planar mirrors and lens systems. According to embodiment as shown in (b) of FIG. 6, the secondary display 309 is present parallel to the primary display 303 here. According to a further embodiment as shown in (c) of FIG. 6, a placement of the secondary display 309 and the primary display 303 is same as shown in (b) of FIG. 6. However, according to this embodiment, the pixel density of the primary display 303 and the pixel density of the secondary display 309 are equal, thus the above projection system 311 may be slightly modified. In FIG. 6, (d) shows a projection system 311 with the convex mirror at the exit and a lens system between the secondary display 309 and the mirror 310. This design may reduce the complexity of the arrangement.

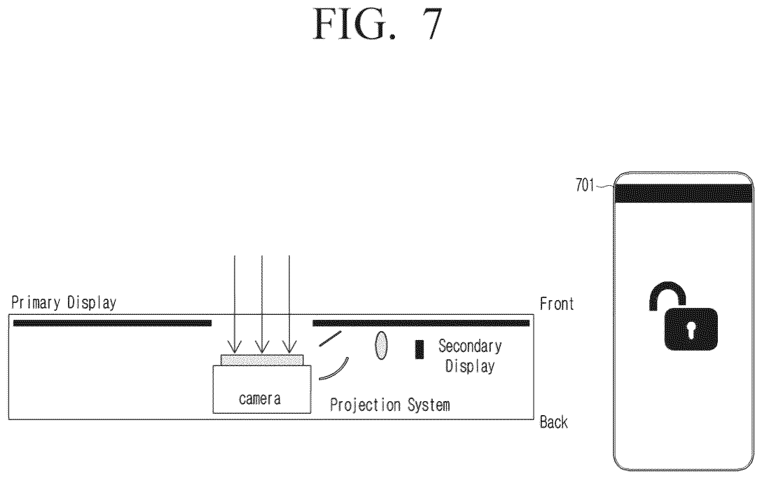

FIG. 7 illustrates an exemplary scenario for real-time face authentication in a sub-display system, according to an example embodiment of the disclosure. According to the example scenario, the user may try to make a payment for some purchase through the electronic device 301. Then, the user may be required to authenticate his identity via a face recognition. Accordingly, the camera turns ON and captures an image when the PWM off signal 701 appears on top of the aperture area. In particular, the image capturing operation is synchronized with passing of the black bands, which is caused by the PWM off signal 701. Hence, enabling simultaneous use of the camera and the secondary display, such that a user can capture images using under-display camera while camera remains hidden. Thus, the end-user will not be able to detect this operation with the naked human eye. Since, the naked human eye is not able to detect this process, the user only sees a full-screen edge-to-edge display without any notch and the authentication take place seamlessly.

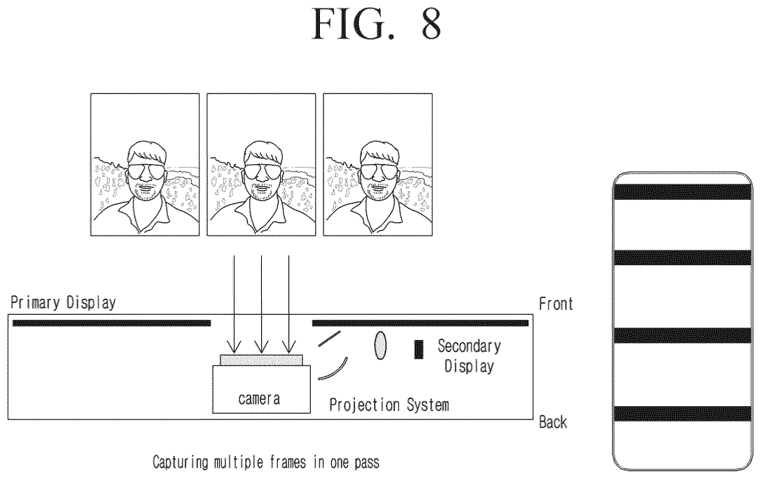

FIG. 8 illustrates another exemplary scenario for handling slow motion scenarios, according to an example embodiment of the disclosure. According to an exemplary scenario, at initially the camera is turned-on whenever there is a trigger for image capturing operation. As an example, the trigger may be for example, an opening of a camera App. FIG. 8 depicts a scenario when multiple frames are captured by the camera. According to the exemplary scenario the multiple frames are captured in one pass. According to an exemplary embodiment, in the current screen's the PWM rate are detected. For example, periods that the PWM is in ON state or the PWM is in OFF state may vary based on the brightness levels at operation 409 and operation 413. At operation 411, the video's output frame rate or fps is detected based on the user or application's input. As an example, the fps of videos may range from 30-60 fps. The fps of photos may depend on implementation. For example, the fps of photos may be as low as 1 frame to multi-frame for better quality while processing. Operations 409, 413, and 411 are already explained in FIG. 4B.

According to an exemplary embodiment, the camera is set to sync with this screen's refreshing, such that the camera captures the light when the PWM off state overlaps with the aperture region. Thereafter, the camera's operating shutter speed/operating frame rate is determined based on operations 409, 413, and 411. According to this example embodiment, multiple frames are captured when a single PWM off state overlaps the aperture region, resulting in a higher frame rate of slow-motion video.

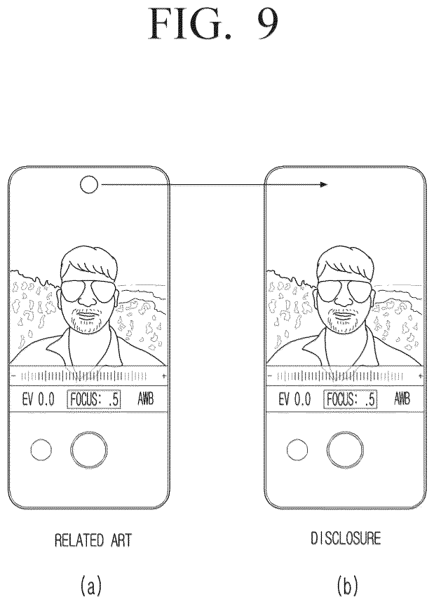

FIG. 9 illustrates a comparison of an output of the disclosure with respect to the related art, according to an example embodiment of the disclosure. (a) of the FIG. 9 shows an implementation of the related art. According to the related art, the area around the aperture is blacked out while capturing the images or videos. This is done to allow light to enter the camera, resulting in a punch-hole/notch being visible while capturing photos. (b) of FIG. 9 shows an example implementation of the disclosure: the front camera is enabled to take pictures while displaying the content edge-to-edge, without the punch-hole or notch being visible to the end user.

The disclosure provides an ability to use the camera and the secondary display simultaneously. Further, unlike the related art, the disclosure may not have mechanical switching involved between camera and secondary display, which may conceal front facing cameras while capturing images as well. Further, as the disclosure provides a non-mechanical solution, and hence, the disclosure provides higher reliability of components and lower aberrations due to prolonged usage.

The disclosure supports multiple different output modules around the camera like secondary display or infrared projector or flash module etc. Multiple of these output modules may be arranged around the aperture, operating in similar manner and in any order.

Some example embodiments of the disclosure may be implemented using processing circuitry. For example, some example embodiments of the disclosure may be implemented using at least one software program running on at least one hardware device and performing network management functions to control the elements.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A method performed by an electronic device, the method comprising:
receiving an input to initiate an image capturing operation using an under-display camera positioned under an aperture region of a primary display of the electronic device;
detecting a modulation rate of the primary display, wherein the modulation rate comprises an ON period and an OFF period;
determining a current operating frame rate of the under-display camera;
synchronizing, when the image capturing operation is in progress, the current operating frame rate associated with the under-display camera with the detected modulation rate,
wherein the synchronizing comprises:
providing display functionality around the aperture region during the ON period of a primary display region overlapping with the aperture region; and
performing image capture, by the under-display camera, during the OFF period of the primary display region overlapping with the aperture region.

2. The method of claim 1, wherein the modulation rate corresponds to a rate of at least one of: Pulse Width Modulation (PWM), Pulse-Amplitude Modulation (PAM), Pulse-Frequency Modulation (PFM), Pulse-Position Modulation (PPM), Delta-Sigma Modulation (DSM), or Space Vector Modulation (SVM).

3. The method of claim 1, wherein the primary display region comprises a pixel array.

4. The method of claim 1, wherein the providing display functionality around the aperture region of the primary display during the ON period is enabled using a secondary display positioned under the primary display of the electronic device.

5. The method of claim 1, wherein the under-display camera is invisible to a human eye when the image capture performed by the under-display camera during the OFF period of the primary display region is in operation.

6. The method of claim 1, wherein the image capturing operation comprises capturing an image through the aperture region by the under-display camera.

7. The method of claim 4, further comprises a projection system comprising multiple refractive and reflective elements present under the primary display, and in front of the secondary display,
wherein the projection system is configured to congregate and project the light from the secondary display onto the aperture region.

8. The method of claim 7, wherein the primary display and the secondary display are in synchronization.

9. An electronic device comprising:
a primary display and a secondary display;
a projection system that is under the primary display and is in front of the secondary display, wherein the projection system comprises multiple refractive and reflective elements and the projection system is configured to congregate and project the light from the secondary display onto an aperture region in the primary display;
an under-display camera below the aperture region; and
at least one processor operatively connected with the projection system, the primary display, the secondary display, and the under-display camera,
wherein the at least one processor is configured to:
receive an input to initiate an image capturing operation using the under-display camera;
detect a modulation rate of the primary display, wherein the modulation rate comprises an ON period and an OFF period;
determine a current operating frame rate of the under-display camera;
synchronize, when the image capturing operation is in progress, the current operating frame rate associated with the under-display camera with the detected modulation rate, and
wherein the synchronizing comprises:
providing display functionality around the aperture region during the ON period of a primary display region overlapping with the aperture region; and
performing image capture, by the under-display camera, during the OFF period of the primary display region overlapping with the aperture region.

10. The electronic device of claim 9, wherein the modulation rate corresponds to a rate of at least one of: Pulse Width Modulation (PWM), Pulse-Amplitude Modulation (PAM), Pulse-Frequency Modulation (PFM), Pulse-Position Modulation (PPM), Delta-Sigma Modulation (DSM), or Space Vector Modulation (SVM).

11. The electronic device of claim 9, wherein the primary display region comprises a pixel array.

12. The electronic device of claim 9, wherein the providing display functionality around the aperture region of the primary display during PWM ON is enabled using the secondary display positioned under the primary display.

13. The electronic device of claim 9, wherein the under-display camera is invisible to a human eye when the image capture performed by the under-display camera during the OFF period of the primary display region is in operation.

14. The electronic device of claim 9, wherein the image capturing operation comprises capturing an image through the aperture region by the under-display camera.

15. The electronic device of claim 14, wherein the primary display and the secondary display are in synchronization.
